(19) United States
(12) Patent Application Publication
(10) Pub. No.: US 2011/0101704 A1
(43) Pub. Date: May 5, 2011

(54) Starter

(75) Inventors: Ming Wai CHAU, Hong kong (CN); Kam Sum WONG, Hong Kong (CN); Yao Liang GAO, Shenzhen (CN); Tian Ru XU, Shenzhen (CN)

(73) Assignee: Johnson Electric S.A., Murten (CH)

(21) Appl. No.: 12/915,738

(22) Filed: Oct. 29, 2010

(30) Foreign Application Priority Data
Oct. 30, 2009 (CN) 200910110435.0
Jul. 7, 2010 (CN) 201010228496.X

(51) Int. Cl. F02N 11/08

(52) U.S. Cl. 290/38 R

(57) ABSTRACT

A starter comprises: an electric motor with an enclosure; a gear train mounted to one end of the motor; and a switch module for controlling operation of the motor. The switch module has an enclosure. The enclosure of the switch module and the enclosure of the motor are integrally formed as a single housing.

### CROSS REFERENCE TO RELATED APPLICATIONS

This non-provisional patent application claims priority under 35 U.S.C. §119(a) from Patent Application No. 200910110435.0 filed in The People's Republic of China on Oct. 30, 2009 and Patent Application No. 201010228496.X filed in The People's Republic of China on Jul. 7, 2010.

### FIELD OF THE INVENTION

This invention relates to a starter for an internal combustion engine such as used for example in garden tractors, lawn mowers, snow blowers, etc.

### BACKGROUND OF THE INVENTION

Electric starters are widely utilized for small gasoline engines such as those used in garden tractors, lawn mowers, snow blowers etc.

A conventional starter comprises an electric motor, a switch module and a gear train. The gear train is fixed to the output end of the motor shaft. The switch module is separated from the motor and connected with the motor by a cable which extends outside of enclosures of the motor and the switch module. However, it is difficult to seal the junction between the cable and the enclosures of the switch module and the motor. Furthermore, the separated switch module and motor occupies much space.

In conventional starters, the enclosure of the switch module comprises a flat surface for mounting a button thereon. However, when the starters are used in a snow blower, snow easily accumulates on the flat surface and as the snow melts, water will enter into the switch module along the gap between the periphery of the button and the enclosure. This is may lead to electrical faults.

In conventional starters used in a snow blower, the plug compartment of the switch module is usually oriented horizontally or even slightly facing upwardly in order to facilitate easy connection to the power cord. Snow easily accumulates in the plug compartment and may lead to difficulty in fitting the plug of the power cord and may short circuit the plug, which is not safe. In order to allow melted snow to drain out of the plug compartment, an opening is formed in the bottom wall of the plug compartment, which complicates the moulding process.

Buttons used in conventional starters usually incorporate a cap made of rubber. When the button is pushed, the cap is deformed. When the button is released, the cap returns to its original shape allowing the button to return to the off state. However, in very cold weather the rubber will become stiff and will not quickly return to its undeformed shape resulting in a button which is hard to operate and prone to remaining in the operated state when released.

### SUMMARY OF THE INVENTION

Hence there is a desire for an improved starter.

Accordingly, in one aspect thereof, the present invention provides a starter comprising: an electric motor; a gear train mounted to one end of the motor; and a switch module for controlling operation of the motor, wherein the switch module comprises an enclosure with a concave mounting surface and a button mounted in a recess in the concave mounting surface.

Preferably, ribs are arranged on the concave mounting surface on opposite sides of the button, the button being sunken relative to the ribs and opposite ends of the curved mounting surface.

Preferably, the button is made of luminous material.

Preferably, the enclosure of the switch module and the enclosure of the motor are integrally formed as a single housing.

Preferably, a cable connects the switch module with the motor, the cable being disposed only within the single housing.

Preferably, the switch module comprises terminals that extend through a wall of the switch enclosure, the switch enclosure forming a plug compartment accommodating exposed ends of the terminals, the plug compartment having an open end arranged to receive a plug for connecting to the exposed ends of the terminals within the plug compartment, and wherein when the starter is fitted to an engine, the open end of the plug compartment is oriented in a downward direction.

Preferably, the switch module further comprises a spring for returning the button to an off position.

According to a second aspect, the present invention provides a starter comprising: an electric motor with an enclosure; a gear train mounted to one end of the motor; and a switch module for controlling operation of the motor, the switch module comprising an enclosure on which a button is mounted, wherein the enclosure of the switch module and the enclosure of the motor are integrally formed as a single housing.

Preferably, a cable connects the switch module to the motor, the cable extending within the single housing.

According to a third aspect, the present invention provides a starter comprising: an electric motor; a gear train mounted to one end of the motor; and a switch module for controlling operation of the motor, the switch module comprising a plug compartment in which terminals are installed, wherein when the starter is installed on an engine, the open end of the plug compartment is oriented downwards.

According to a further aspect, the present invention provides a starter comprising: an electric motor; a gear train mounted to one end of the motor; and a switch module for controlling operation of the motor, wherein the switch module comprises a button and a spring for returning the button to an off position.

Preferably, the switch module comprises an enclosure with a mounting surface, the button being mounted on the mounting surface.

Preferably, the switch module further comprises a sealing structure for sealing a gap between the button and the mounting surface.

Preferably, the sealing structure comprises a membrane attached to the mounting surface and covering the button and the gap between the button and the mounting surface.

Preferably, the membrane comprises a cavity for receiving the button and a flange extending from periphery of the cavity, the flange being bonded to the mounting surface.

Preferably, the mounting surface has a recess, the button is received in the recess and wherein the sealing structure is a sealing ring arranged in the gap between the button and the recess.

Preferably, the mounting surface includes a concave surface and a recess in the concave surface accommodating the button.

Preferably, the motor comprises an enclosure, the enclosure of the motor being integrally formed with the enclosure of the switch module.

Preferably, the switch module comprises terminals that extend through a wall of the enclosure of the switch module, the enclosure being molded over the terminals and forms a plug compartment accommodating exposed ends of the terminals, the plug compartment having an open end arranged to receive a plug for connecting to the exposed ends of the terminals within the plug compartment.

### BRIEF DESCRIPTION OF THE DRAWINGS

A preferred embodiment of the invention will now be described, by way of example only, with reference to figures of the accompanying drawings. In the figures, identical structures, elements or parts that appear in more than one figure are generally labelled with a same reference numeral in all the figures in which they appear. Dimensions of components and features shown in the figures are generally chosen for convenience and clarity of presentation and are not necessarily shown to scale. The figures are listed below.

FIG. 1 is an isometric view of a starter in accordance with an embodiment of the present invention;

FIG. 2 is an enlarged view of a portion of a switch module being a part of the starter of FIG. 1;

FIG. 3 is a side view of a part of the starter of FIG. 1;

FIG. 4 is a schematic cross-sectional view of a part of the switch module of the starter of FIG. 1;

FIG. 5 illustrates a starter in accordance with an alternative embodiment of the present invention; and

FIG. 6 is a schematic cross-sectional view of a part of the switch module of the starter of FIG. 5.

### DETAILED DESCRIPTION OF THE PREFERRED EMBODIMENTS

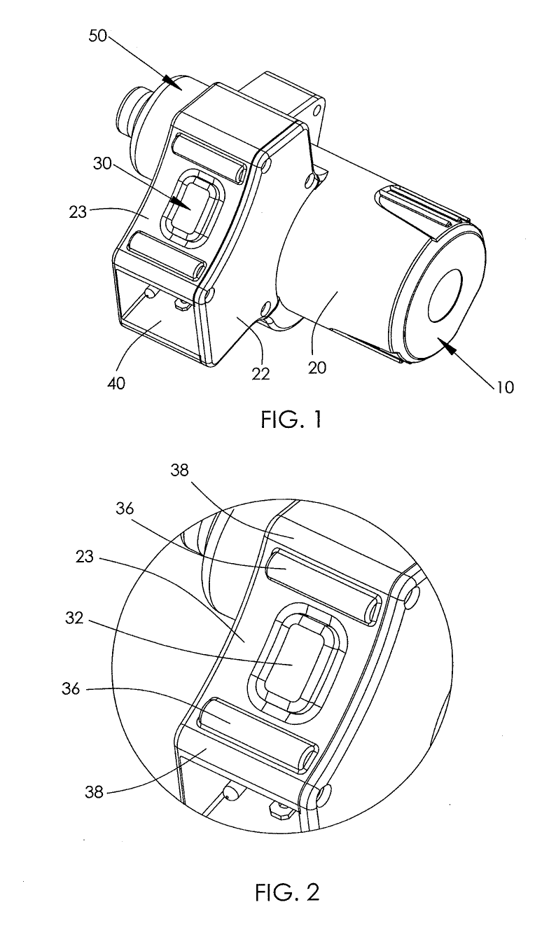

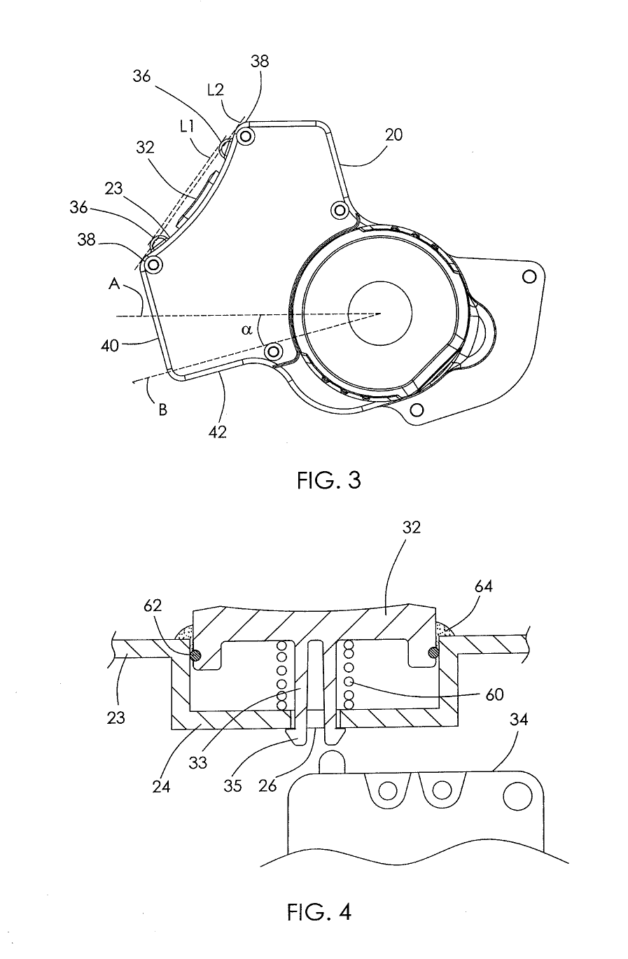

FIGS. 1 to 4 illustrate a starter in accordance with a first embodiment of the present invention. The starter comprises an electric motor 10, a switch module 30 and a gear train 50. The electric motor 10 and the switch module 30 share a common enclosure 20. That is, the enclosure of the motor 10 and the enclosure of the switch module 30 are integrally formed, creating a single housing. A cable (not shown) electrically connected between the switch module 30 and the motor 10 extends within the enclosure 20. The enclosure 20 may be formed of plastic material. The enclosure 20 has an opening in one side of the switch module 30 for installing components of the switch module and a cover 22 covers the opening.

The enclosure 20 has a mounting surface 23 for mounting of a button 32 of the switch module 30. The mounting surface 23 is curved and the middle portion thereof is sunken relative to opposite ends. Thus, the mounting surface 23 is a concave surface. When the starter is installed on the engine of device such as a snow blower, said opposite ends of the concave mounting surface 23 are located vertically spaced. Thus, snow does not easily accumulate on the mounting surface 32 to avoid melted snow (water) entering the switch module 30 through the gap between the button 32 and the mounting surface 23.

A protective rib 36 is formed at each of said opposite ends of the mounting surface 32. Imaginary connecting line L1 extending tangentially between the ribs 36 is spaced outwardly from the surface of the button 32. Imaginary connecting line L2 extending tangentially between said opposite ends of the mounting surface 23 is also spaced outwardly from the surface of the button 32. That is, the button 32 is sunk relative to the imaginary connecting lines L1 and L2. In addition, the imaginary connecting line L2 is located between the imaginary connecting line L1 and the surface of the button 32. Thus, the ribs 36 and the opposite ends of the mounting surface 23 cooperatively provide a double safe guard to protect the button 32 from being accidentally pushed. The ribs and the concave mounting surface also provide increased feel guiding the thumb or finger of an operator to positively engage the button when required, even when the operator is wearing gloves.

As shown in FIG. 4, the switch module 30 further comprises a spring 60 for holding the button in the off position and for returning the button 32 to the off position when released after being pressed to the on position. The spring 60 surrounds a projection 33 formed on a bottom part of the button 32. The projection 33 has a tip 35 forming a rear facing shoulder. The projection passes through a hole 26 in a rear wall 24 of a recess in the mounting surface 23. The recess is provided to accommodate the button, such that the top of the button may be close to or flush with the surrounding mounting surface. The shoulder of the tip 35 rests against an inner surface of the rear wall 24 when the button is in the off position. The spring 60 is disposed between the button 32 and the rear wall 24. When the button 32 is pressed the spring 60 is compressed and the projection 33 moves through the hole 26 to engage and operate a switch 34 mounted within the switch module 30. After the button 32 is released the spring 60 returns the button 32 to the off position, releasing the switch 34. The force generated by the spring 60 when the button 32 is pressed, does not change significantly with temperature, even in very cold weather. Thus the force required to operate the switch remains relatively constant regardless of the ambient temperature. The projection 33 is preferably segmented to allow easy assembly with the hole 26.

Preferably, a sealing ring 62, such as a rubber o-ring seal, is provided between the periphery of the button 32 and the mounting surface 23 to prevent any snow 64 on the periphery of the button 32 entering into the switch module 30. As shown, the sealing ring is located between sides of the button and sides of the recess, allowing the button to slide.

Optionally, the button 32 is made of luminous material such that end users can easily find it in the dark. Preferably, the button 32 is rectangular and has a size similar to the size of a thumb of the notional average person.

The switch module 30 further comprises a plug compartment 40 accommodating terminals for connecting to a power source. The plug compartment is formed as part of the enclosure for the switch module. The terminals extend through a wall of the enclosure so as to have free ends exposed in the plug compartment arranged to receive or mate with a plug of the power cord for connecting the starter to the power supply. To ensure a water tight connection between the enclosure and the terminals, the enclosure is moulded directly to the terminals, for example by using an insert moulding process. The plug compartment has an open end for receiving the plug of the power cord and a bottom wall 42. When the starter is fitted to the engine of a snow blower, etc., the open end of the plug compartment 40 is oriented downwardly. That is, the bottom wall 42 of the plug compartment 40 is inclined relative to the ground with the open end facing towards the ground. Thus, snow in the plug compartment 40 easily drains out of the plug compartment 40 as it melts, even if there is no opening in the bottom wall 42. Understandably, the angle α between the bottom wall 42 (indicated by line B) and the ground (indicated by horizontal line A) may be more than 0 degrees and less than 180 degrees. In this embodiment, the angle α is 30 degree.

The gear train 50 is mounted to the output end of the shaft of the motor 10. The shaft (not shown) of the motor 10 extends into the gear train 50. When the starter is fitted to the engine of a snow blower, in use, the gear train 50 engages a flywheel or ring gear of the engine in order to rotate the engine. The gear train may be any of the conventionally used gear trains including a simple Bendix gear train or a complex reduction gear train with or without torque limitation, over running clutch and anti-kick out, positive engagement mechanisms.

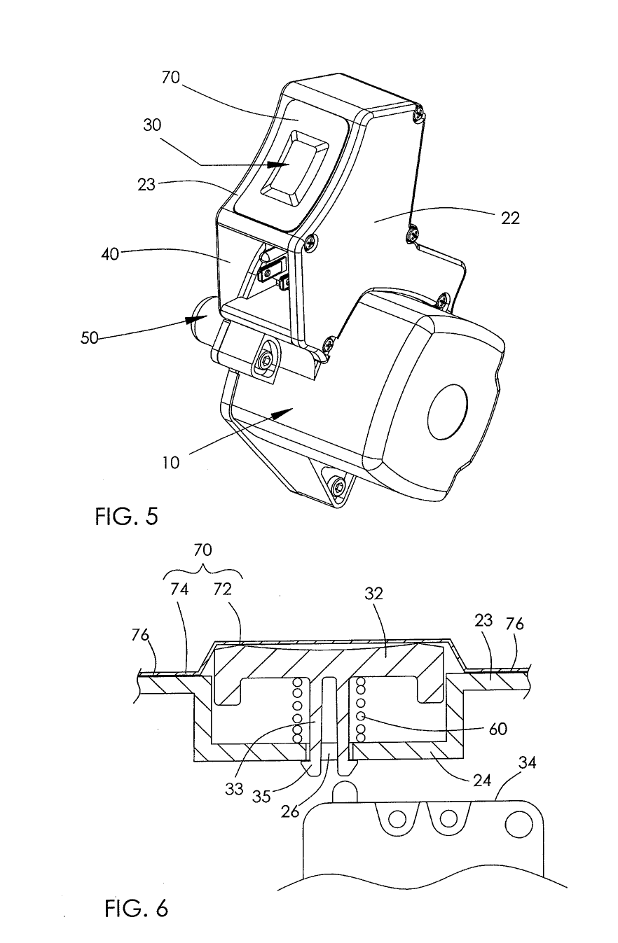

FIGS. 5 and 6 show a starter in accordance with a second preferred embodiment of the present invention. This starter is similar to the starter of FIGS. 1 to 4, except for the sealing structure used to seal the button 32 of the switch module 30. In this embodiment the sealing structure comprises a membrane 70 which is attached to the mounting surface 23 and covers the button 32 and the gap between the button 32 and the mounting surface 23. The membrane 70 comprises a cavity 72 for receiving the button 32 and a flange 74 extending from the periphery of the cavity 72. The flange 74 is bonded to the mounting surface 23 by adhesive 76 to thereby seal the button 32. Preferably, the membrane 70 is made of PET. Alternatively, the membrane 70 may be made of other soft flexible material. Alternatively, the membrane may be bonded to the mounting surface by other bonding methods, such as plastic welding or ultrasonic welding.

In comparison with the sealing ring 62 described above, the membrane 70 does not increase the force needed to move the button 32. Furthermore, the membrane 70 stops snow entering into the gap between the button 32 and the mounting surface 23 and blocking movement of the button 32. Snow or water entering the gap between the button and the mounting surface may freeze or turn to ice and temporarily seize the button even though the water does not actually pass the seal or enter inside the switch module. This situation is prevented by the use of the membrane which totally seals the area of the mounting surface around the button.

In the description and claims of the present application, each of the verbs “comprise”, “include”, “contain” and “have”, and variations thereof, are used in an inclusive sense, to specify the presence of the stated item but not to exclude the presence of additional items.

Although the invention is described with reference to one or more preferred embodiments, it should be appreciated by those skilled in the art that various modifications are possible. Therefore, the scope of the invention is to be determined by reference to the claims that follow.

1. A starter comprising:
an electric motor;
a gear train mounted to one end of the motor; and
a switch module for controlling operation of the motor,
wherein the switch module comprises an enclosure with a concave mounting surface and a button mounted in a recess in the concave mounting surface.

2. The starter of claim 1, wherein ribs are arranged on the concave mounting surface on opposite sides of the button, the button being sunken relative to the ribs and opposite ends of the curved mounting surface.

3. The starter of claim 1, wherein the button is made of luminous material.

4. The starter of claim 1, wherein the enclosure of the switch module and the enclosure of the motor are integrally formed as a single housing.

5. The starter of claim 4, further comprising a cable connecting the switch module with the motor, wherein the cable extends only within the single housing.

6. The starter of claim 1, wherein the switch module comprises terminals that extend through a wall of the switch enclosure, the switch enclosure forming a plug compartment accommodating exposed ends of the terminals, the plug compartment having an open end arranged to receive a plug for connecting to the exposed ends of the terminals within the plug compartment, and wherein when the starter is fitted to an engine, the open end of the plug compartment is oriented in a downward direction.

7. The starter of claim 1, wherein the switch module further comprises a spring for returning the button to an off position.

8. A starter comprising:
an electric motor with an enclosure;
a gear train mounted to one end of the motor; and
a switch module for controlling operation of the motor, the switch module comprising an enclosure on which a button is mounted,
wherein the enclosure of the switch module and the enclosure of the motor are integrally formed as a single housing.

9. The starter of claim 8, further comprising a cable connecting the switch module to the motor, wherein the cable extends within the single housing.

10. A starter comprising:
an electric motor;
a gear train mounted to one end of the motor; and
a switch module for controlling operation of the motor, the switch module comprising a plug compartment in which terminals are installed,
wherein when the starter is installed on an engine, the open end of the plug compartment is oriented downwards.

11. A starter comprising:
an electric motor;
a gear train mounted to one end of the motor; and
a switch module for controlling operation of the motor,
wherein the switch module comprises a button and a spring for returning the button to an off position.

12. The starter of claim 11, wherein the switch module comprises an enclosure with a mounting surface, the button being mounted on the mounting surface.

13. The starter of claim 12, wherein the switch module further comprises a sealing structure for sealing a gap between the button and the mounting surface.

14. The starter of claim 13, wherein the sealing structure comprises a membrane attached to the mounting surface and covering the button and the gap between the button and the mounting surface.

15. The starter of claim 14, wherein the membrane comprises a cavity for receiving the button and a flange extending from periphery of the cavity, the flange being bonded to the mounting surface.

16. The starter of claim 14, wherein the membrane is a PET membrane.

17. The starter of claim 13, wherein the mounting surface has a recess, the button is received in the recess and wherein the sealing structure is a sealing ring arranged in the gap between the button and the recess.

18. The starter of claim 12, wherein the mounting surface includes a concave surface and a recess in the concave surface accommodating the button.

19. The starter of claim 12, wherein the motor comprises an enclosure, the enclosure of the motor being integrally formed with the enclosure of the switch module.

20. The starter of claim 12, wherein the switch module comprises terminals that extend through a wall of the enclosure of the switch module, the enclosure being molded over the terminals and forms a plug compartment accommodating exposed ends of the terminals, the plug compartment having an open end arranged to receive a plug for connecting to the exposed ends of the terminals within the plug compartment.
